(19) United States
(12) Patent Application Publication
(10) Pub. No.: US 2006/0045443 A1
(43) Pub. Date: Mar. 2, 2006

(54) Fiber optic ribbons having one or more preferential tear portions and method of making the same

(76) Inventor: Bradley J. Blazer, Granite Falls, NC (US)

Correspondence Address: CORNING CABLE SYSTEMS LLC, P O BOX 489, HICKORY, NC, 28603, US

(21) Appl. No.: 10/929,981

(22) Filed: Aug. 30, 2004

(51) Int. Cl. G02B 6/44

(52) U.S. Cl. 385/114

(57) ABSTRACT

According to certain aspects of the present invention, a fiber optic ribbon is disclosed including a plurality of optical fibers arranged in a generally planar configuration, and a matrix disposed generally about the plurality of optical fibers. The matrix has a substantially continuous outer surface and defines an internal discontinuity spaced from the outer surface. The discontinuity weakens the matrix at the discontinuity, thereby forming a preferential tear area. Various options and modifications to the above structure are disclosed. Also, related methods of forming fiber optic ribbons are disclosed.

### TECHNICAL FIELD

The present invention relates generally to fiber optic ribbons. More specifically, the invention relates to fiber optic ribbons having one or more preferential tear portions for separating optical fibers within the fiber optic ribbon, and to related methods of making separable fiber optic ribbons.

### BACKGROUND

Fiber optic ribbons include optical waveguides such as optical fibers that transmit optical signals, for example, voice, video, and/or data information. Fiber optic cables using optical fiber ribbons can result in a relatively high optical fiber-density. Fiber optic ribbon configurations can be generally classified into two general categories. Namely, fiber optic ribbons with subunits and those without. A fiber optic ribbon with a subunit configuration, for example, includes at least one optical fiber surrounded by a primary matrix forming a first subunit, and a second subunit having a similar construction, which are contacted and/or encapsulated by a secondary matrix. On the other hand, fiber optic ribbons without subunits generally have a plurality of optical fibers surrounded by a single matrix material.

Optical fiber ribbons without subunits can present problems for the craft. For example, when separating these optical fiber ribbons into optical fiber subsets, the craft must use expensive precision tools. Moreover, connectorization/splice procedures can require inventories of specialized splice and closure units/tools for the various subsets of optical fibers. Where the craft elects to separate the optical fiber ribbon into subsets by hand, or with a tool lacking adequate precision, stray optical fibers and/or damage to the optical fibers can result. Stray optical fibers can cause problems in optical ribbon connectorization, organization, stripping, and splicing. Additionally, damage to the optical fibers is undesirable and can render the optical fiber inoperable for its intended purpose.

However, there are fiber optic ribbon configurations that attempt to aid the separation of fiber optic ribbons without using subunits. For example, U.S. Pat. No. 5,982,968 requires an optical fiber ribbon of uniform thickness having V-shaped stress concentrations in the matrix material that extend along the longitudinal axis of the fiber optic ribbon. V-shaped stress concentrations can be located across from each other on the planar surfaces of the fiber optic ribbon, thereby aiding the separation of the fiber optic ribbon into subsets. However, the '968 patent requires a wider fiber optic ribbon because additional matrix material is required adjacent to the optical fibers near the V-shaped stress concentrations to avoid stray optical fibers after separation. A wider ribbon requires more matrix material and decreases the optical fiber density. Another embodiment of the patent requires applying a thin layer of a first matrix material around optical fibers to improve geometry control such as planarity of the optical fibers. Then V-shaped stress concentrations are formed in a second matrix applied over the first matrix material, thereby allowing separation of the subsets at the stress concentrations.

Another example of a separable fiber optic ribbon is described in U.S. Pat. No. 5,970,196. More specifically, the '196 patent requires a pair of removable sections positioned in V-shaped notches located across from each other on opposite sides of the planar surfaces of an optical fiber ribbon. The removable sections are positioned between adjacent interior optical fibers of the optical fiber ribbon to facilitate the separation of the optical fiber ribbon into subsets at the V-shaped notches. The removable sections can either be flush with the planar surfaces of the optical fiber ribbon, or they may protrude therefrom. These known fiber optic ribbons have several disadvantages. For example, they can be more expensive and difficult to manufacture. Additionally, from an operability standpoint, the V-shaped stress concentrations and/or V-shaped notches can undesirably affect the robustness of the optical fiber ribbon and/or induce microbending in the optical fibers.

Other fiber optic ribbons are known having an embedded “rip-cord” to assist in separating portions of the ribbon. In such ribbons, a fine thread or wire is formed within the matrix structure. By pulling the rip-cord out of the side of the ribbon, a preferential tear region is created. An example of such a fiber optic ribbon is OFC 21, sold by Nextrom, Inc. Such ribbons can be complex to manufacture and require an extra element, namely the rip-cord. Also, such ribbons can be difficult to selectively separate at different locations along the length of the ribbon since access to the embedded rip-cord may be difficult to obtain, particularly spaced from an end of the ribbon. Obtaining access to and utilizing the rip-cord might also cause inadvertent damage to other portions of the ribbon at times. Also, utilizing a rip-cord can cause surface irregularities in the outer matrix, which may be detrimental in some applications.

Optical fiber ribbons having subunits can have several advantages, for example, improved separation, and avoidance of stray fiber occurrences. Conventionally, such ribbons include a plurality of subunits, each having optical fibers encapsulated within a primary matrix. The subunits are encapsulated within a secondary matrix. The thicknesses of the primary and secondary matrix are substantially continuous and uniform.

However, such optical fiber ribbons may also have disadvantages. For example, one concern is the potential formation of “wings” extending from the subunits during hand separation of the subunits. Wings can be caused by, for example, a lack of sufficient adhesion between the common (secondary) matrix and the subunit (primary) matrix and/or random fracturing of the secondary matrix during separation. The existence of wings can negatively affect, for example, optical ribbon organization, connectorization, stripping, and/or splicing operations by the craft. Additionally, wings can cause problems with ribbon identification markings, or compatibility of the subunit with ribbon handling tools, for example, thermal strippers, splice chucks, and fusion splicers.

### SUMMARY

According to certain aspects of the present invention, a fiber optic ribbon is disclosed including a plurality of optical fibers arranged in a generally planar configuration, and a matrix disposed generally about the plurality of optical fibers. The matrix generally inhibits movement of the optical fibers in a longitudinal direction so as to form an elongated structure. The matrix has a substantially continuous outer surface and defines an internal discontinuity spaced from the outer surface. The discontinuity weakens the matrix at the discontinuity, thereby forming a preferential tear area. Various options and modifications are possible. For example, the matrix may be made of a first material and the discontinuity may be one of a void, a plurality of bubbles, or a second material different than the first material.

Also, the fiber optic ribbon may include an outer surface, and the ribbon may further include a marking on the fiber optic ribbon outer surface corresponding to the location of the discontinuity. Further, the discontinuity may be formed along a pre-selected length of the fiber optic ribbon less than the entire length of the fiber optic ribbon.

The matrix may comprise a primary matrix generally contacting the optical fibers, and the ribbon may further include a secondary matrix disposed generally about the primary matrix. The secondary matrix may have a substantially continuous outer surface and define an internal discontinuity spaced from the secondary matrix outer surface, wherein the discontinuity in the secondary matrix weakens the secondary matrix at the discontinuity, thereby forming a secondary preferential tear area.

The matrix may comprise a secondary matrix, and the ribbon may further include a primary matrix disposed generally about the plurality of optical fibers, the secondary matrix disposed generally about the primary matrix. The primary matrix may have an outer surface including a surface discontinuity, thereby forming a preferential tear area in one of the primary matrix or the secondary matrix. The surface discontinuity may comprise an area of non-uniform thickness, and the area of non-uniform thickness may comprise at least one indentation or at least one raised area.

At least two of the discontinuities may be formed in the matrix on opposite sides of the plurality of optical fibers, thereby forming a single preferential tear area. Alternatively, at least two of the discontinuities may be formed in the matrix on a given side of the plurality of optical fibers, thereby forming either a single preferential tear area or two separate preferential tear areas spaced from each other with at least one of the plurality of optical fibers therebetween.

According to certain other aspects of the invention, a fiber optic ribbon is disclosed including a first subunit having a first plurality of optical fibers arranged in a generally planar configuration, and a first primary matrix disposed generally about the first plurality of optical fibers. The first primary matrix generally inhibits movement of the optical fibers in a longitudinal direction, thereby forming an elongated structure. A second subunit includes a second plurality of optical fibers arranged in a generally planar configuration, and a second primary matrix is disposed generally about the second plurality of optical fibers. The second primary matrix generally inhibits movement of the optical fibers in a longitudinal direction, thereby forming an elongated structure. A secondary matrix is disposed generally about the first and second subunits and has a substantially continuous outer surface. The secondary matrix defines an internal discontinuity spaced from the secondary matrix outer surface, the discontinuity weakening the secondary matrix at the discontinuity, thereby forming a preferential tear area. As above, various options and modifications are possible.

According to other aspects of the invention, a method of making a fiber optic ribbon is disclosed, including the steps of providing a plurality of optical fibers; arranging the plurality of optical fibers in a generally planar configuration; forming a matrix generally about the plurality of optical fibers so as to form a substantially continuous outer surface about the matrix; and forming an internal discontinuity within the matrix spaced from the outer surface so as to weaken the matrix at the discontinuity, thereby forming a preferential tear area. Again, various options and modifications are possible.

For example, the matrix may be a primary matrix, and the method may include the further steps of forming a secondary matrix generally about the primary matrix so as to form a substantially continuous outer surface, and forming a discontinuity within the secondary matrix spaced from the secondary matrix out surface so as to weaken the matrix at the discontinuity, thereby forming a preferential tear area. Also, the matrix may be a secondary matrix, and the method may include the further steps of forming a primary matrix generally about the plurality of optical fibers, and forming the secondary matrix generally about the primary matrix. The method may also include the further step of forming a discontinuity in the primary matrix generally spaced from a substantially continuous outer surface of the primary matrix, the discontinuity weakening the primary matrix at the discontinuity, thereby forming a preferential tear area.

The step of forming a discontinuity may include one of forming a void, forming bubbles, or locating a material different than a material of the matrix at the discontinuity. The step of forming a matrix may include extruding the matrix about the plurality of optical fibers. The step of forming a discontinuity may include forming at least two discontinuities.

The fiber optic ribbon may also include an outer surface, and the method may include the further step of marking the outer surface corresponding to the location of the discontinuity. The step of forming the discontinuity may also include forming the discontinuity along a pre-selected length of the fiber optic ribbon less than the entire length of the fiber optic ribbon.

### BRIEF DESCRIPTION OF THE DRAWINGS

FIG. 1 is a cross-sectional view of a fiber optic ribbon according to certain aspects of the present invention.

FIG. 2 is a cross-sectional view of another fiber optic ribbon according to certain other aspects of the present invention.

FIG. 3 is a cross-sectional view of a third fiber optic ribbon according to certain other aspects of the present invention.

FIG. 4 is a cross-sectional view of a fourth example of a fiber optic ribbon according to certain other aspects of the present invention.

FIG. 5 is a cross-sectional view of a fifth fiber optic ribbon according to certain other aspects of the present invention.

FIG. 6 is a cross-sectional view of yet another fiber optic ribbon according to certain other aspects of the present invention.

FIG. 7 is a cross-sectional view of a seventh fiber optic ribbon according to certain other aspects of the present invention.

FIG. 8 is a cross-sectional view of an eighth fiber optic ribbon according to certain other aspects of the present invention.

FIG. 9 is a perspective diagrammatical view of the outside of a fiber optic ribbon according to certain other aspects of the present invention.

FIG. 10 is a schematic view of one or more methods of manufacturing fiber optic ribbons according to certain aspects of the present invention.

FIG. 11 is a schematic cross-sectional view of one example of a portion of a die head useful in the methods shown in FIG. 10 and described herein.

### DETAILED DESCRIPTION

Detailed reference will now be made to the drawings in which examples embodying the present invention are shown. The detailed description uses numerical and letter designations to refer to features in the drawings. Like or similar designations in the drawings and description have been used to refer to like or similar parts of the invention.

The drawings and detailed description provide a full and written description of the invention, and of the manner and process of making and using it, so as to enable one skilled in the pertinent art to make and use it, as well as the best mode of carrying out the invention. However, the examples set forth in the drawings and detailed description are provided by way of explanation of the invention and are not meant as limitations of the invention. The present invention thus includes any modifications and variations of the following examples as come within the scope of the appended claims and their equivalents. Further, the embodiments below, or aspects of the embodiments, may be combined to achieve further embodiments, all within the scope of the present invention.

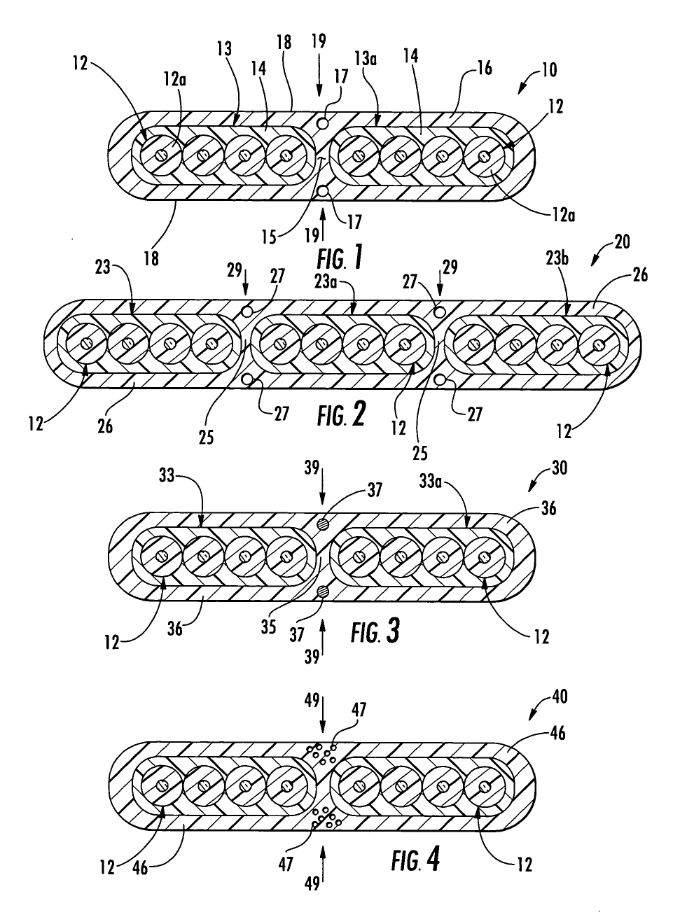

Illustrated in FIG. 1 is a fiber optic ribbon 10 according to certain aspects of the present invention. Fiber optic ribbon 10 (hereinafter ribbon) includes a plurality of optical waveguides, for example, optical fibers 12 arranged in a generally planar configuration within two matrices 14 forming elongate structures around the optical fibers. As shown, the optical fibers 12 are separated into two subunits, 13, 13a each having a discrete matrix 14. As used herein, subunit means a plurality of optical fibers having a discrete matrix material thereon. In other words, each subunit has its own individual matrix material thereon. Subunits should not be confused with subsets, which are optical fibers arranged as groups having a common matrix material. When subunits are separated the discrete matrix material generally remains intact on each subunit. However, ribbons according to the present invention can use other suitable types or numbers of ribbons as subunits.

The two matrices 14 form primary matrices since they are generally disposed within a secondary matrix 16. Ribbon 10 can, for example, be used as a stand-alone ribbon, a portion of a ribbon stack, or as a subunit of a larger ribbon. Respective primary matrices 14 are disposed generally about and generally contact respective optical fibers 12 and may encapsulate the same, thereby providing a robust structure for processing and handling by inhibiting relative movement among optical fibers. However, primary matrices 14 need not entirely encapsulate respective optical fibers 12.

Secondary matrix 16 can have material characteristics that are similar to or different than primary matrices 14. For example, the primary matrix around the edge fibers of subunits 13, 13a can be relatively soft to cushion the same and inhibit optical attenuation therein. Additionally, secondary matrix may have a lower modulus than the primary matrix to ease fracture of the same. The generally flat planar surfaces 18 of secondary matrix 16 allow stacking of ribbon 10 for the formation of a ribbon stack. However, other suitable shapes of secondary matrix 16 can be used. In this embodiment, one or more internal discontinuities, in this case voids 17, may be employed in either of the matrices to form a preferential tear portion 19. In FIG. 1, preferential tear portion 19 extends across the center of secondary matrix 16 and includes voids 17, but variations are possible, as discussed below.

Optical fibers 12 may be a plurality of single-mode optical fibers; however, other types or configurations of optical fibers can be used. For example, optical fibers 12 can be multi-mode, pure-mode, erbium doped, polarization-maintaining fiber, other suitable types of light waveguides, and/or combinations thereof. For instance, each optical fiber 12 can include a silica-based core that is operative to transmit light and is surrounded by a silica-based cladding having a lower index of refraction than the core. Additionally, one or more coatings can be applied to optical fiber 12. For example, a soft primary coating surrounds the cladding, and a relatively rigid secondary coating surrounds the primary coating. The coating can also include an identifying means such as ink or other suitable indicia for identification and/or an anti-adhesion agent that inhibits the removal of the identifying means. Suitable optical fibers are commercially available from Corning Incorporated of Corning, N.Y. For simplicity of illustration herein, core and optional cladding are shown as element 12a.

Each primary matrix 14 and/or secondary matrix 16 can be, for example, a radiation curable material or a polymeric material; however, other suitable materials can be used. As known to one skilled in the art, radiation curable materials undergo a transition from a liquid to a solid when irradiated with predetermined radiation wavelengths. Before curing, the radiation curable material includes a mixture of formulations of, for example, liquid monomers, oligomer “backbones” with acrylate functional groups, photoinitiators, and other additives. Typical photoinitiators function by: absorbing energy radiated by the radiation source; fragmenting into reactive species; and then initiating a polymerization/hardening reaction of the monomers and oligomers. Generally, as a result of irradiation, a cured solid network of cross-linking is formed between the monomers and oligomers, which may include fugitive components. Stated another way, the photoinitiator begins a chemical reaction that promotes the solidification of the liquid matrix into a generally solid film having modulus characteristics.

The resulting modulus of radiation curable materials can be controlled by factors such as radiation intensity and cure time. The radiation dose, i.e., the radiant energy arriving at a surface per unit area is inversely proportional to the line speed, i.e., the speed the radiation curable moves past the radiation source. The light dose is the integral of radiated power as a function of time. In other words, all else being equal, the faster the line speed, the higher the radiation intensity must be to achieve adequate curing. After a radiation curable material has been fully irradiated, the material is said to be cured. Curing occurs in the radiation curable material from the side facing the radiation source down or away from the source. Because portions of the material closer to the radiation source can block radiation from reaching non-cured portions of the material, a cure gradient can be established. Depending on the amount of incident radiation, a cured material may exhibit different degrees of curing. Moreover, the degrees of curing in a material can have distinct modulus characteristic associated therewith. Conversely, multiple radiation sources or reflectors can be positioned so that the matrix material has a relatively uniform cure.

Thus, the degree of cure affects the mechanical characteristics through the cross-link density of the radiation curable material. For example, a significantly cured material can be defined as one with a high cross-link density for that material, which is, for example, too brittle. Further, an undercured material may be defined as one having a low cross-link density, and can be too soft, possibly having a relatively high coefficient of friction (COF) that causes an undesirable level of ribbon friction. The cured UV material has a modulus, for example, in the range of about 50 MPa to about 1500 MPa depending on the radiation dose. Different modulus values can provide varying degrees of performance with respect to, for example, hand separability and robustness of the ribbons of the present invention.

If desired, a UV curable material may be used for primary matrix 14 and/or secondary matrix 16. For example, the UV curable material may be a polyurethane acrylate resin commercially available from DSM Desotech Inc. of Elgin Ill. such as 950-706. Alternatively, other suitable UV materials can be used, for example, polyester acrylate resin commercially available from Borden Chemical, Inc. of Columbus, Ohio. Additionally, thermoplastic materials such as polypropylene can be used as a matrix material. Methods of manufacturing ribbons according to the present invention using such materials are discussed in more detail below.

Using more than one matrix can have several advantages. For example, in one embodiment a thin primary matrix 14 can be applied simply to ensure planarity of the optical fibers in the ribbon. Additionally, secondary matrix 16 can have several functions. For example, secondary matrix 16 can be used impart generally planar surfaces 18 to ribbon 10. Planar surfaces 18 can also provide stability when ribbon 10 is used as a portion of a ribbon stack. Additionally, secondary matrix 16 may also provide material characteristics that are different from primary matrix 14 such as adhesion, COF characteristics, or hardness. This can be accomplished, for example, by using a secondary matrix 16 material that is similar to primary matrix 14 with different processing characteristics such as cure characteristics, or by using a material that is different than primary matrix 14. Likewise, different portions of secondary matrix 16 may have different materials and/or may have distinct material characteristics.

Illustratively, a first planar surface of secondary matrix 16 can have a predetermined COF, while the second planar surface can have a high adhesion to primary matrix 14. A predetermined COF on the planar surface allows the ribbon to relieve strain, for example, during bending of a stack of ribbons, while a high adhesion characteristic between the primary and secondary matrices can make for a generally robust ribbon. In other embodiments, the first and second planar surfaces can have the same characteristics, which may differ from the characteristics of the primary matrix. Additionally, as disclosed in U.S. Pat. No. 6,253,013, which is incorporated in its entirety herein by reference, an adhesion zone (not shown) can be used between primary matrix 14 and secondary matrix 16. For example, the adhesion zone may be applied to primary matrix 14 using a Corona discharge treatment. Additionally, as described below, a marking indicia for identifying ribbon 10 can be printed either on primary matrix 14 or secondary matrix 16. In other embodiments, secondary matrix 16 can be used to identify ribbon 10. For example, secondary matrix 16 can be colored with a dye for identification of the ribbon. Likewise, other suitable configurations are possible for identifying individual ribbons such as stripes, or tracers, and/or printing.

Ribbon 10 advantageously inhibits the formation of, for example, wings and/or stray optical fibers during separation. Ribbon 10 inhibits the formation of wings by having the preferential tear portion 19 in secondary matrix 16, rather than allowing random fracturing in secondary matrix 16. Specifically, preferential tear portion 19 is generally located at a point of internal discontinuity, generally adjacent to a subunit interface 15 of secondary matrix 16. The discontinuity can be formed in various ways, as will be discussed below. In this case, the internal discontinuity is one or more voids 17 formed in secondary matrix 16. When secondary matrix 16 includes voids 17 formed therein, the thickness of secondary matrix 16 is effectively diminished at that point. Accordingly, secondary matrix 16 is weakened at the point of discontinuity, thereby forming preferential tear portion 19. Formation of wings during separation of subunits 13, 13a is thereby inhibited since the fracture of primary matrix 16 generally occurs through voids 17. Additionally, using suitable matrix characteristics such as elongation to break and/or a predetermined matrix modulus can enhance the characteristics of preferential tear portion 19.

Voids 17 may be formed by feeding a fluid which may be a gas, such as ambient air or a particular gas mixture, or a liquid into the die head used for forming primary matrix 14, as will be discussed below. Voids 17 may be essentially continuous, that is running from one end of ribbon 10 to the other, or the voids may be discontinuous, that is having sections where voids are present and other sections where voids are not present. If discontinuous, voids 17 may have lengths as small as about 1 millimeter with spacing in between on the range of about 1 millimeter or so, or the voids and/or spacing may extend for much longer lengths such as centimeters, meters, many multiple meters, etc. Thus, with regard to the use of voids 17, various scenarios are possible within the scope of the invention to achieve various types and locations of preferential tear portions.

As depicted in FIGS. 2-8, a preferential tear portion can be accomplished with numerous other suitable ribbon and internal discontinuity designs. For example, FIG. 2 shows a ribbon 20 similar in most respects to ribbon 10 of FIG. 1. However, as shown, ribbon 20 includes three subunits 23, 23a, 23b generally surrounded by a secondary matrix 26 rather than two. Also, two preferential tear portions 29 are created at interfaces 25 between adjacent subunits by way of voids 27. Therefore, ribbon 10 of FIG. 1 can be readily split into two portions whereas ribbon 20 of FIG. 2 can be readily split into three portions, each portion of both ribbons having four optical fibers disposed within a given subunit of the primary matrix. Again, any number of subunits can be utilized within a secondary matrix according to the invention.

FIG. 3 shows a ribbon 30 similar to that of FIG. 1 having subunits 33, 33a held in a primary matrix 36 with preferential tear portions 39 located at interface 35, except that voids 17 have been replaced with a co-extruded material 37. Co-extruded material 37 is shown disposed at generally the same location within secondary matrix 16 as are voids in ribbon 10; however, other configurations are possible. Co-extruded material 37 may be a material similar to that of secondary matrix 16, but having a lower modulus, cross-link density, etc. Alternatively, entirely different materials could be used such as different polymers, etc. In preferred embodiments, co-extruded material 37 has a low adhesion to primary matrix 36, thereby inhibiting coupling between the two materials. Thus, it should be understood that the internal discontinuity need not be formed by a void per se, but can be formed by another material that forms a discontinuity in the matrix material.

FIG. 4 depicts another concept of the present invention with regard to a ribbon 40. Ribbon 40 of FIG. 4 is substantially similar to ribbons 10 and 20 of FIGS. 1 and 3, except that ribbon 40 includes a bubbled (i.e., foamed) area 47 as its internal discontinuity. Such bubbling or foaming can be created by various methods such as injecting a different material or processing a secondary matrix 46 material differently with a fluid. Thus, a relatively larger void, such as in FIG. 1 need not be used, and a larger group of smaller voids (the bubble/foam area) may be used to create a preferential tear portion 49 within secondary matrix 46.

FIG. 5 shows another example of a ribbon 50 in which a plurality of voids 57 are used to create a preferential tear portion 59. As shown, two voids 57 are disposed at the top side of secondary matrix 56 and three voids 57 are disposed at a bottom side of secondary matrix 56. It would be possible to use either two or three, or any other number of voids, on either or both sides of the secondary matrix of a ribbon according to the present invention. Thus, ribbon 50 shows that any plurality and/or arrangement of voids can be used to form the internal discontinuity according to the present invention. Use of additional voids may cause a greater weakening within secondary matrix 56, which could be more desirable for certain applications or with certain materials. For example, if the material of secondary matrix 56 were desired to be stronger, more voids could be used in certain applications, however the secondary matrix need not be stronger for use of multiple voids within the scope of the invention.

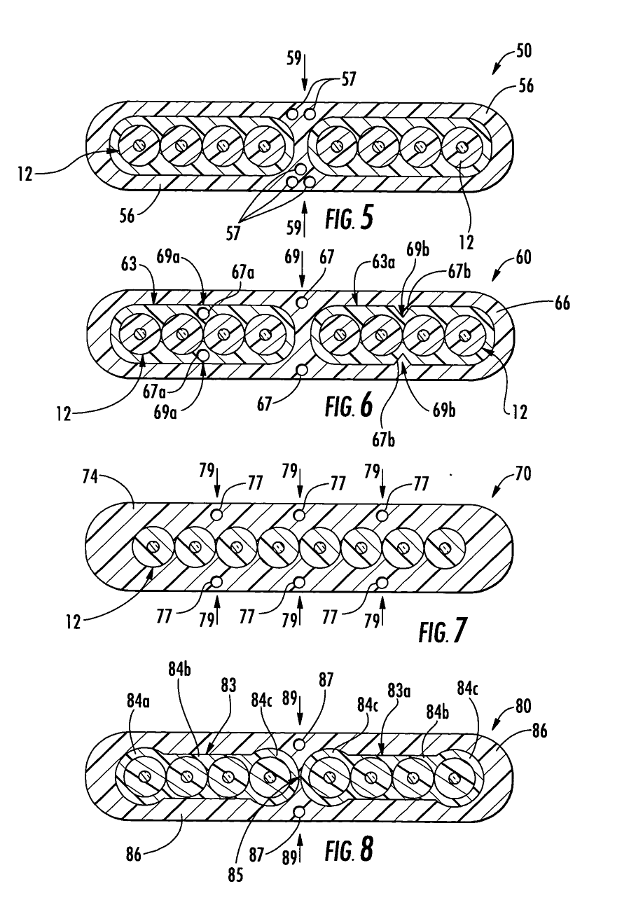

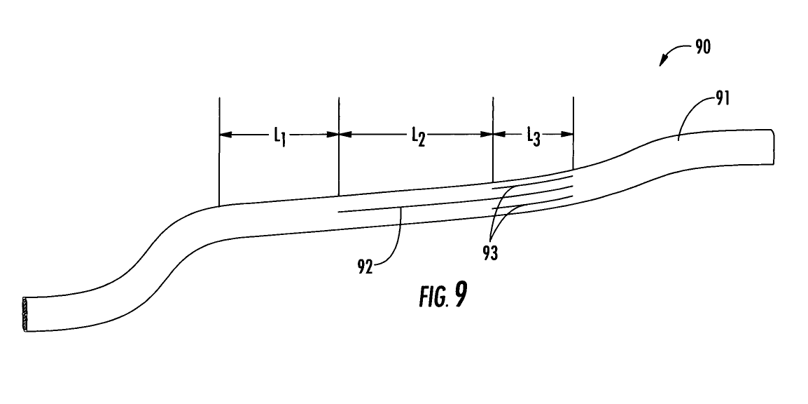

FIG. 6 shows a ribbon 60 similar to that of FIG. 1 but having two differences. First, subunit 63 itself includes two voids 67a which provides a preferential tear area 69a within subunit 63. Also, subunit 63a includes two surface discontinuities 67b, in the form of v-shaped notches, forming preferential tear areas 69b in subunit 63a. Thus, ribbon 60 is an example showing that internal voids or discontinuities 67, 67a can be used within subunits and/or secondary matrices to provide preferential tear portions 69, 69a if desired. Also, ribbon 60 shows that subunits may have surface discontinuities or voids for forming subunit preferential tear areas therein for forming secondary preferential tear portions in subunits.

FIG. 7 shows yet another embodiment of a ribbon 70 according to certain aspects of the present invention. As shown, ribbon 70 has no subunits per se, but has a single matrix 74 disposed about optical fibers 12. As shown, ribbon 70 includes eight optical fibers 12, but any other number of fibers could be used. Also, six voids 77 are shown creating three separate preferential tear portions 79, allowing separation of ribbon 70 into four portions having two fibers each. As stated above, voids 77 could be replaced by other types of internal discontinuities, and different numbers and/or placements of the voids are possible, including placement of a single void on a given side of matrix 74 to create the preferential tear portion. Also, voids 77 could be placed on alternating sides of matrix 74 or all on a single side of matrix 74, if desired. Thus, use of a primary and a secondary matrix is not necessary according to the present invention, and multiple preferential tear portions may be utilized within a single given matrix to separate out the fibers into various groups. If desired, ribbon 70 could itself comprise a primary matrix and be surrounded by a secondary matrix, with or without subunits.

FIG. 8 shows another ribbon 80 according to various aspects of the invention. Ribbon 80 is similar to ribbon 10 of FIG. 1, except that subunits 83, 83a have bulbous end portions 84a and 84c that extend from a narrower central portion 84b as disclosed in U.S. Pat. No. 6,748,148 and U.S. patent application Ser. No. 10/411,406 filed on Apr. 10, 2003, the disclosures of which are incorporated herein by reference. These bulbous portions can assist in creating preferential tear portions in the secondary matrix 86 by influencing the formation of the fracture at a preferential tear portion 89. If desired, the extending portions may have shapes other than “bulbous”, and/or the bulbous portions may be disposed only where preferential tear portions are desired, such as at interface 85, rather than on both ends of subunits 83, 83a. Again, voids 87 comprise internal discontinuities within secondary matrix 86, although any of the above disclosures regarding placement or type of the internal discontinuity could apply to ribbon 80 as well.

Thus, as set forth in FIGS. 1-8, numerous options and modifications are possible for the specific structures expressly shown in FIGS. 1-8, as described herein. Further, various elements from the various embodiments can be recombined to obtain new embodiments within the scope of the invention. The type and location of internal discontinuity is not considered limiting, and neither is the placement within any primary and/or secondary matrix so as to provide a preferential tear portion or portions therein.

It is important to note that the internal discontinuity described herein is not considered to include a “rip-cord” as described above. The internal discontinuity herein comprises a fluid such as a gas or liquid in the form of a void, a foam, bubbles, or an alternate material injected during the die head formation of the matrix. Placement of a thread or wire during some part of the formation of the matrix is not considered to form an internal discontinuity as defined herein.

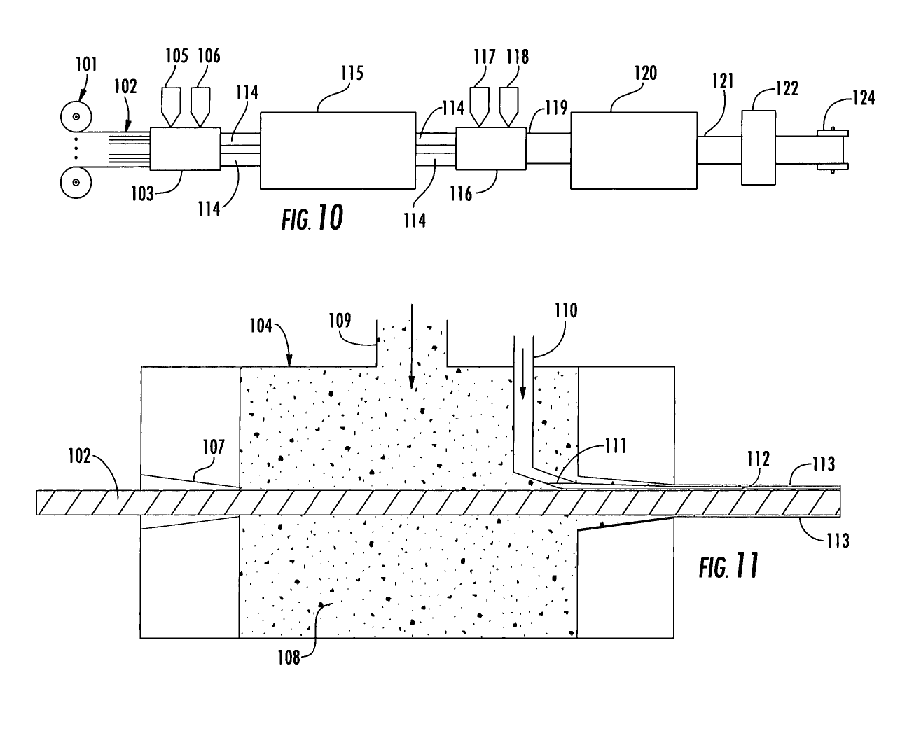

FIG. 9 shows an example of a ribbon 90 including an outer surface 91 having markings thereon that correspond to locations of internal discontinuities. As shown, a first marking 92 extends through portions L2 and L3, and second markings 93 extend through portion L3. No marking is shown in portion L1. As an example, marking 92 could indicate a first internal discontinuity that would separate two subunits, whereas markings 93 could indicate preferential tear portions within subunits. Of course, various options are possible here, regarding the type and placement of the marking, as well as the type and placement of the preferential tear portions. It is possible that subunit preferential tear portions extend throughout the entire ribbon 90, but that secondary matrix preferential tear portions only extend for a portion of the ribbon. Thus, any pre-selected length of the fiber optic ribbon less than the entire length of the fiber optic ribbon may have any sort of external marking disposed thereon to indicate presence of a preferential tear portion therein, caused either by an internal discontinuity, or a surface discontinuity of a matrix or a subunit. Alternatively, the preferential tear portions could extend the entire length of the ribbon.

FIGS. 10 and 11 show in diagrammatical form an exemplary method for making a fiber optic ribbon. As shown, one or more supply reels 101 supply optical fibers 102 used for making a ribbon. Optical fibers 102 are fed to at least one applicator 103 having a die head assembly 104 (see FIG. 11). A supply 105 of material for a matrix is provided to applicator 103, along with a secondary supply 106 of material or substance for creating one or more internal discontinuities within the matrix. A fiber inlet 107 of die head assembly 104 allows fibers 102 to enter a die head chamber 108. A material inlet 109 of the die head assembly 104 allows matrix material to enter the chamber 108 from supply 105, and a second material inlet 110 allows the material or substance from supply 106 to enter chamber 108. An outlet 111 of second material inlet 110 is disposed so as to create the internal discontinuity 112 within matrix 113 formed about fibers 102. As illustrated by way of example in FIG. 10, two subunits 114 exit applicator 103, although it should be understood that any number of fibers and matrices, including units or subunits may be employed. Subunits 114 then enter oven 115, which may be a UV curing oven, as described above. If other materials are utilized, an oven may not be necessary. Also, oven 115 may be formed essentially integral with applicator 103 in a single assembly.

The process may be then repeated, whereby subunits 114 enter a second applicator 116 having first and second supplies 117 and 118 similar to those described above. A ribbon 119 including a secondary matrix disposed around subunits 114 exits applicator 116 and enters curing oven 120. A cured ribbon 121 is then sent to a marking device 122 and then wound onto a take up reel 124.

As should be apparent from the above, with all of the various different design possibilities for making ribbons, primary and/or secondary matrices, etc., the various elements of the method shown in FIG. 10 may be modified accordingly in numerous ways. For example, initial supply reels 101 could supply one or more existing subunits to an applicator, thereby eliminating one of the applicators from the process. Also, either of the supplies 106 or 108 could be eliminated depending on the desired locations of internal discontinuities, and external discontinuities could be created on subunits within die head 103, if desired. Supplies 106 and 118 could be used to create voids, bubbles/foam, or could supply different materials, and the shape of outlets 111 would be accordingly modified. Also, the number of and location of outlets 111 could be modified as needed to place the internal discontinuities as required.

Thus, FIGS. 10 and 11, in view of the preceding figures, disclose various different methods for manufacturing fiber optic ribbons wherein a plurality of optical fibers are provided, the fibers are arranged in a generally planar configuration, and matrix is formed generally about the plurality of optical fibers so as to form a substantially continuous outer surface about the matrix, and an internal discontinuity is formed within the matrix spaced from the outer surface so as to weaken the matrix at the discontinuity, thereby forming a preferential tear area. The method can be performed so as to create primary and secondary matrices, wherein the discontinuities are located in one or more of the primary or secondary matrices. A marking device may be used to mark an outer surface of the ribbon so as to indicate a location of the internal discontinuity or for making ribbon identification markings. Also, the supplies 106 and 118 may be manipulated so that the formed discontinuities are formed only along a pre-selected length of the fiber optic ribbon, or along the entire length of the fiber optic ribbon, as desired.

Many modifications and other embodiments of the present invention, within the scope of the appended claims, will become apparent to a skilled artisan. Therefore, it is to be understood that the invention is not to be limited to the specific embodiments disclosed herein and that modifications and other embodiments may be made within the scope of the appended claims. Although specific terms are employed herein, they are used in a generic and descriptive sense only and not for purposes of limitation. The invention has been described with reference to silica-based optical fibers, but the inventive concepts of the present invention are applicable to other suitable optical waveguides as well.

What is claimed is:

1. A fiber optic ribbon comprising:
a plurality of optical fibers arranged in a generally planar configuration; and
a matrix disposed generally about the plurality of optical fibers, the matrix generally inhibiting movement of the optical fibers in a longitudinal direction so as to form an elongated structure, the matrix having a substantially continuous outer surface and defining an internal discontinuity spaced from the outer surface, the internal discontinuity weakening the matrix at the internal discontinuity, thereby forming a preferential tear area.

2. The fiber optic ribbon of claim 1, wherein the matrix is made of a first material and the internal discontinuity is one of a void, a plurality of bubbles, or a second material different than the first material.

3. The fiber optic ribbon of claim 1, wherein the fiber optic ribbon includes an outer surface, and further including a marking on the fiber optic ribbon outer surface corresponding to the location of the internal discontinuity.

4. The fiber optic ribbon of claim 3, wherein the internal discontinuity is formed along a pre-selected length of the fiber optic ribbon less than the entire length of the fiber optic ribbon.

5. The fiber optic ribbon of claim 1, wherein the matrix comprises a primary matrix generally contacting the plurality of optical fibers, and further including a secondary matrix disposed generally about the primary matrix.

6. The fiber optic ribbon of claim 5, wherein the secondary matrix has a substantially continuous outer surface and defines an internal discontinuity spaced from the secondary matrix outer surface, the internal discontinuity in the secondary matrix weakening the secondary matrix at the internal discontinuity, thereby forming a secondary preferential tear area.

7. The fiber optic ribbon of claim 1, wherein the matrix comprises a secondary matrix, and further including a primary matrix disposed generally about the plurality of optical fibers, the secondary matrix disposed generally about the primary matrix.

8. The fiber optic ribbon of claim 7, wherein the primary matrix has an outer surface including a surface discontinuity, thereby forming a preferential tear area in one of the primary matrix or the secondary matrix.

9. The fiber optic ribbon of claim 8, wherein the surface discontinuity comprises an area of non-uniform thickness.

10. The fiber optic ribbon of claim 9, wherein the area of non-uniform thickness comprises at least one indentation.

11. The fiber optic ribbon of claim 9, wherein the area of non-uniform thickness comprises at least one bulbous portion.

12. The fiber optic ribbon of claim 1, wherein at least two of the internal discontinuities are formed in the matrix on opposite sides of the plurality of optical fibers, thereby forming at least one preferential tear area.

13. The fiber optic ribbon of claim 1, further comprising at least two internal discontinuities that are formed in the matrix on a given side of the plurality of optical fibers, thereby forming at least one preferential tear area.

14. The fiber optic ribbon of claim 1, further comprising at least two of the internal discontinuities that are formed in the matrix on a given side of the plurality of optical fibers, thereby forming at least two separate preferential tear areas spaced from each other with at least one of the plurality of optical fibers therebetween.

15. A fiber optic ribbon comprising:
a first subunit including a first plurality of optical fibers arranged in a generally planar configuration, and a first primary matrix disposed generally about the first plurality of optical fibers, the first primary matrix generally inhibiting movement of the optical fibers in a longitudinal direction so as to form an elongated structure;
a second subunit including a second plurality of optical fibers arranged in a generally planar configuration, and a second primary matrix disposed generally about the second plurality of optical fibers, the second primary matrix generally inhibiting movement of the optical fibers in a longitudinal direction so as to form an elongated structure; and
a secondary matrix disposed generally about the first and second subunits and having a substantially continuous outer surface, the secondary matrix defining at least one internal discontinuity spaced from the secondary matrix outer surface, the internal discontinuity weakening the secondary matrix at the internal discontinuity, thereby forming a preferential tear area.

16. The fiber optic ribbon of claim 15, wherein the secondary matrix is made of a first material and the internal discontinuity is one of a void, a plurality of bubbles, or a second material different than the first material.

17. The fiber optic ribbon of claim 15, wherein the fiber optic ribbon includes an outer surface, and further including a marking on the fiber optic ribbon outer surface corresponding to the location of the internal discontinuity.

18. The fiber optic ribbon of claim 17, wherein the internal discontinuity is formed along a pre-selected length of the fiber optic ribbon less than the entire length of the fiber optic ribbon.

19. The fiber optic ribbon of claim 15, wherein the primary matrix of at least one of the subunits has a substantially continuous outer surface, the primary matrix defining an internal discontinuity spaced from the primary matrix outer surface, the internal discontinuity weakening the primary matrix at the internal discontinuity, thereby forming a preferential tear area.

20. The fiber optic ribbon of claim 15, wherein the primary matrix of at least one subunit has an outer surface including a surface discontinuity, thereby forming a preferential tear area in one of the primary matrix or the secondary matrix.

21. The fiber optic ribbon of claim 20, wherein the surface discontinuity comprises an area of non-uniform thickness.

22. The fiber optic ribbon of claim 21, wherein the area of non-uniform thickness comprises at least one indentation.

23. The fiber optic ribbon of claim 21, wherein the area of non-uniform thickness comprises at least bulbous portion.

24. The fiber optic ribbon of claim 15, further comprising at least two internal discontinuities that are formed in the secondary matrix on opposite sides of the plurality of optical fibers, thereby forming at least one preferential tear area.

25. The fiber optic ribbon of claim 15, further comprising at least two internal discontinuities that are formed in the secondary matrix on a given side of the plurality of optical fibers, thereby forming at least one preferential tear area.

26. The fiber optic ribbon of claim 15, further comprising at least two internal discontinuities that are formed in the secondary matrix on a given side of the plurality of optical fibers, thereby forming two separate preferential tear areas spaced from each other with at least one of the plurality of optical fibers therebetween.

27. A method of making a fiber optic ribbon comprising the steps of:
providing a plurality of optical fibers;
arranging the plurality of optical fibers in a generally planar configuration;
forming a matrix generally about the plurality of optical fibers; and
forming an internal discontinuity within the matrix spaced from the outer surface so as to weaken the matrix at the internal discontinuity, thereby forming a preferential tear area.

28. The method of claim 27, wherein the matrix is a primary matrix, and including the further steps of:
forming a secondary matrix generally about the primary matrix; and
forming an internal discontinuity within the secondary matrix spaced from the secondary matrix out surface so as to weaken the matrix at the internal discontinuity, thereby forming a preferential tear area.

29. The method of claim 27, wherein the matrix is a secondary matrix, and including the further steps of:
forming a primary matrix generally about the plurality of optical fibers; and
forming the secondary matrix generally about the primary matrix.

30. The method of claim 29, including the further step of:
forming an internal discontinuity in the primary matrix generally spaced from an outer surface of the primary matrix, the internal discontinuity weakening the primary matrix at the internal discontinuity, thereby forming a preferential tear area.

31. The method of claim 27, wherein the step of forming the internal discontinuity includes one of forming a void, forming bubbles, or locating a material different than a material of the matrix at the internal discontinuity.

32. The method of claim 27, wherein the step of forming the internal discontinuity includes forming at least two internal discontinuities.

33. The method of claim 27, wherein the fiber optic ribbon includes an outer surface, and including the further step of:
marking the outer surface corresponding to the location of the internal discontinuity.

34. The method of claim 27, wherein the step of forming the internal discontinuity includes forming the internal discontinuity along a pre-selected length of the fiber optic ribbon less than the entire length of the fiber optic ribbon.
